(19) United States
(12) Patent Application Publication
(10) Pub. No.: US 2006/0028476 A1
(43) Pub. Date: Feb. 9, 2006

(54) Method and system for providing extensive coverage of an object using virtual cameras

(76) Inventor: Irwin Sobel, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/911,463

(22) Filed: Aug. 3, 2004

(51) Int. Cl. G06T 15/70; G06T 13/00

(52) U.S. Cl. 345/474

(57) ABSTRACT

A system and method for generating texture information. Specifically, a method provides for extensive coverage of an object using virtual cameras. The method begins by tracking a moveable object in a reference coordinate system. By tracking the moveable object, an object based coordinate system that is tied to the object can be determined. The method continues by collecting at least one replacement image from at least one video sequence of the object to form a subset of replacement images of the object. The video sequence of the object is acquired from at least one reference viewpoint, wherein the reference viewpoint is fixed in the reference coordinate system but moves around the object in the object based coordinate system. The subset of replacement images is stored for subsequent incorporation into a rendered view of the object.

### TECHNICAL FIELD

The present invention relates to the field of video communication within a shared virtual environment, and more particularly to a method and system for using moving virtual cameras to obtain extensive coverage of an object.

### BACKGROUND ART

Video communication is an established method of collaboration between remotely located participants. In its basic form, a video image of a remote environment is broadcast onto a local monitor allowing a local user to see and talk to one or more remotely located participants. More particularly, immersive virtual environments attempt to simulate the experience of a face-to-face interaction for participants who are, in fact, geographically dispersed but are participating and immersed within the virtual environment.

The immersive virtual environment creates the illusion that a plurality of participants, who are typically remote from each other, occupy the same virtual space. Essentially, the immersive virtual environment consists of a computer model of a three-dimensional (3D) space, called the virtual environment. For every participant in the virtual environment, there is a 3D model to represent that participant. The models are either pre-constructed or reconstructed in real time from video images of the participants. In addition to participants, there can be other objects that can be represented by 3D models within the virtual environment.

Every participant and object has a virtual pose that is defined by their corresponding location and orientation within the virtual environment. The participants are typically able to control their poses so that they can move around in the virtual environment. In addition, all the participant and object 3D models are placed, according to their virtual poses, in a 3D model of the virtual environment to make a combined 3D model. A view (e.g., an image) of the combined 3D model is created for each participant to view on their computer monitor. A participant's view is rendered using computer graphics from the point of view of the participant's virtual pose.

One of the problems associated with communication in an immersive virtual environment in conventional methods and systems is that some or all of the video texture information needed to render a participant as seen from a viewpoint in the virtual environment may not be available as generated from current images of cameras generating real-time images of the participant. That is, if the cameras are capturing frontal shots of a the participant, rendered views of the back of the participant based on the images from the cameras are not available.

Prior art solutions are inadequate in that it is quite obvious that the view of the back of the participant does not portray a natural view of the participant when there is insufficient video texture information from current images. For instance, if there are no images available to generate a rendered view of an object from a viewpoint in a virtual environment, a rendered view of the object may be substituted by a solid color, such as green. For instance, a rendered view of the participant from the rear will show an outline of the back of the participant's head that is devoid of features and filled in with green. In another case, boundary texture pixels are extrapolated into the empty image locations to fill in missing texture information. However, extrapolated data produces unnatural streaking across the rendered view of the participant. In both cases, the rendered view is unnatural, thereby disturbing the simulation of the immersive virtual environment.

Therefore, previous methods of video communication were unable to satisfactorily provide for extensive coverage of participants that is natural within an immersive virtual environment.

### SUMMARY

A system and method for generating texture information. Specifically, a method provides for extensive coverage of an object using virtual cameras. The method begins by tracking a moveable object in a reference coordinate system. By tracking the moveable object, an object based coordinate system that is tied to the object can be determined. The method continues by collecting at least one replacement image from at least one video sequence of the object to form a subset of replacement images of the object. The video sequence of the object is acquired from at least one reference viewpoint, wherein the reference viewpoint is fixed in the reference coordinate system but moves around the object in the object based coordinate system. The subset of replacement images is stored for subsequent incorporation into a rendered view of the object.

### BRIEF DESCRIPTION OF THE DRAWINGS

FIG. 1A is a diagram of a top view of a desktop immersive system for capturing video streams in real-time of a participant, in accordance with one embodiment of the present invention.

FIG. 1B is a diagram of a front view of the desktop immersive system of FIG. 1A for capturing video streams in real-time of a participant, in accordance with one embodiment of the present invention.

FIG. 2A is a diagram of a reference coordinate system and an object based coordinate system used for providing extensive coverage of an object, in accordance with one embodiment of the present invention.

FIG. 2B is a diagram of the reference coordinate system and the object based coordinate system of FIG. 2A illustrating the change in position and orientation of the object based coordinate system as the object changes its position and orientation.

FIG. 3 is a flow diagram illustrating steps in a computer implemented method for providing extensive coverage of an object using moving virtual cameras, in accordance with one embodiment of the present invention.

FIG. 4 is a flow diagram illustrating steps in a computer implemented method for collecting and storing replacement images in a subset of replacement images, in accordance with one embodiment of the present invention.

FIG. 5 is a block diagram of a system that is capable of collecting and storing replacement images in a subset of replacement images, in accordance with one embodiment of the present invention.

### BEST MODES FOR CARRYING OUT THE INVENTION

Reference will now be made in detail to the preferred embodiments of the present invention, a method and system of providing extensive coverage of an object using virtual cameras. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention can be implemented on software running on a computer system. The computer system can be a personal computer, notebook computer, server computer, mainframe, networked computer, handheld computer, personal digital assistant, workstation, mobile phone, and the like. This software program is operable for providing extensive coverage of an object using virtual cameras. In one embodiment, the computer system includes a processor coupled to a bus and memory storage coupled to the bus. The memory storage can be volatile or non-volatile and can include removable storage media. The computer can also include a monitor, provision for data input and output, etc.

Accordingly, the present invention provides a method and system for providing extensive coverage of an object using virtual cameras. In particular, embodiments of the present invention are capable of filling in gaps of coverage with natural representations of an object captured using virtual cameras. As a result, the representative texture information can be stored for later view construction.

In general, an immersive virtual environment creates the illusion of a plurality of participants occupying the same virtual space, or environment. That is, given a plurality of participants who are typically remote from each other in a physical environment, an immersive virtual environment allows for the interaction of the participants within the immersive virtual environment, such as a virtual meeting. In one embodiment, the immersive virtual environment is created by a computer model of a three-dimensional (3D) space.

Within the immersive virtual environment, for every participant, there is a 3D model to represent that participant. In one embodiment, the models are reconstructed from video images of the participants. The video images can be generated from one or more image capturing devices (e.g., cameras) that surround a participant. In one embodiment, video streams of the images are generated in real-time from multiple perspectives. From these multiple video streams, various reconstruction methods can be implemented to generate a 3D model of the participant. A view of the participant can be rendered from the 3D model of the participant that is taken from any virtual viewpoint within the immersive virtual environment. In this manner, a more realistic representation of the participant is presented within the immersive virtual environment, such as, a virtual conference room. In addition to participants, there can be other objects in the virtual environment. The objects also have 3D model representations.

In still another approach, new-view synthesis techniques can be used to render a viewing participant within an immersive virtual environment. New view synthesis techniques are capable of rendering objects to arbitrary viewpoints, and may or may not create a 3D model as an intermediate step. In this approach, the viewing participant is rendered, using new view synthesis, to exactly the same viewpoint as previously described to create a 2D image of the participant. The immersive virtual environment may be rendered separately to create a 2D virtual environment image. The 2D image of the participant can then be composited with the 2D virtual environment image to create an image that is identical to the previously described rendering of a 3D combined model.

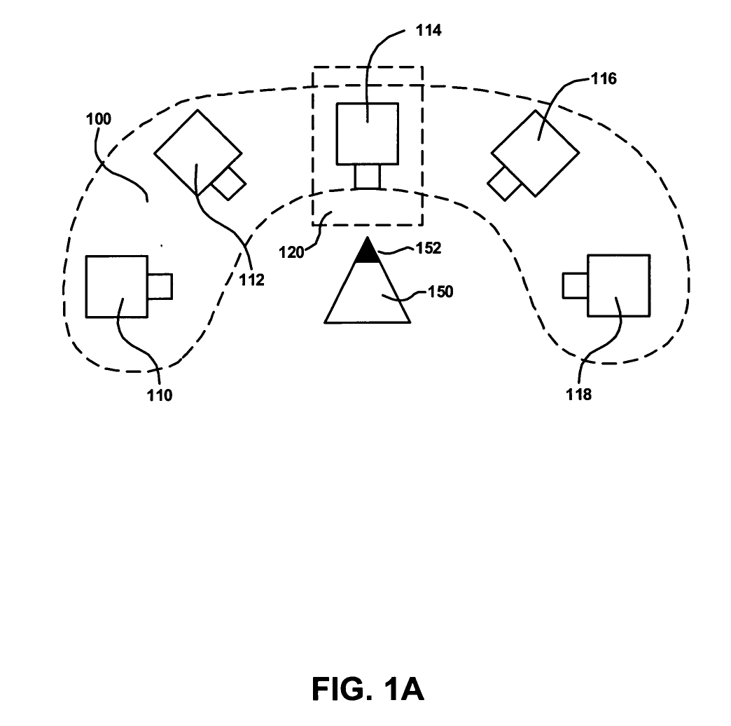

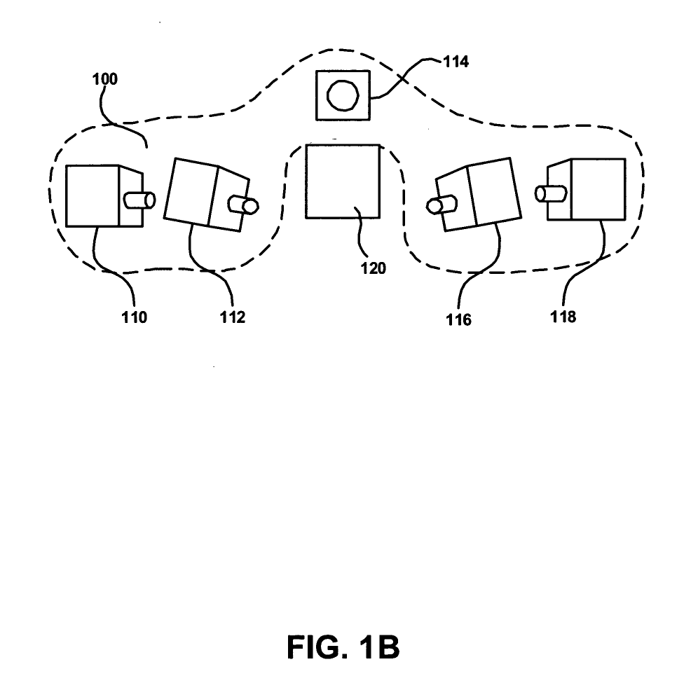

Referring now to FIGS. 1A and 1B, an exemplary camera array 100 comprises a plurality of camera acquisition modules, or image capturing devices, that surround a participant 150, in embodiments of the present invention. The camera array 100 is used for simultaneously acquiring video images of the participant 150. In one embodiment, the camera acquisition modules are digital recording video cameras. The various video streams from the camera array 100 are used to generate the 3D model of the participant 150 using various reconstruction methods.

Referring to FIG. 1A, a cross-sectional view from the top of the camera array 100 is shown, in accordance with one embodiment of the present invention. In the present embodiment, the camera array 100 consisting of five separate cameras (camera acquisition module 110, 112, 114, 116, and 118) is placed on top of a conventional personal computer (PC) display 120 associated with the participant 150. For instance, the display 120 can be used by the participant 150 for viewing an immersive virtual environment within which the participant 150 is participating.

Although five separate cameras are used in the present embodiment, it is possible to increase or decrease the number of cameras depending on image quality and system cost. Increasing the number of cameras increases the image quality. In addition, the cameras within the camera array 100 may be situated anywhere within a room or physical environment for capturing video images of the participant 150, or of any object of interest. Also, varying forms of the camera array 100 can be implemented. For example, a less powerful version of camera array 100 with one or more cameras can be implemented to generate plain two dimensional video streams, or fully synthetic avatars.

As illustrated in FIG. 1A, the five camera acquisition modules 110, 112, 114, 116, and 118 all face and wrap around the participant 150. The participant 150 faces the five camera acquisition modules. That is the darkened point 152 of the triangle representing participant 150 is the front of the participant 150. In addition, the camera array 100 produces five video streams in real-time from multiple perspectives via the five camera acquisition modules 110, 112, 114, 116, and 118. Each of the video streams contains at least one image of the participant 150. From these multiple video streams, various reconstruction methods, or new view synthesis techniques, can be implemented to generate new views of the participant 150 with respect to a location of the participant 150 within a coordinate space of the immersive virtual environment. That is, new views of the participant 150 are generated from arbitrary perspectives representing viewpoints within the coordinate space of the immersive virtual environment. In one embodiment, generation of the new views can occur in real-time to provide for real-time audio and video communication within the immersive virtual environment.

FIG. 1B is a cross-sectional front view illustrating the camera array 100 of FIG. 1A comprising the plurality of camera acquisition modules 110, 112, 114, 116, and 118. As shown, the camera array 100 can be a single unit that is attached directly to the display 120. Other embodiments are well suited to camera acquisition modules that are not contained within a single unit but still surround the participant 150, and to camera acquisition modules that are not attached directly to the display 120, such as placement throughout a media room to capture larger and more complete images of the participant 150. Additionally, as shown in FIG. 1A, the placement of camera acquisition module 114 is higher than the remaining camera acquisition modules 110, 112, 116, and 118, in the present embodiment; however, other embodiments are well suited to placement of the camera acquisition modules on a singular horizontal plane, for arbitrary placement of the camera acquisition modules, and/or for non-uniform displacement of the camera acquisition modules.

In the immersive virtual environment, every participant and object has a virtual pose. The virtual pose comprises the location and orientation of the participant or object in the virtual environment. Participants are typically able to control their poses so that they can move around in the virtual environment.

All of the 3D model representations of the participants and objects are placed, according to their virtual poses, in the 3D model of the virtual environment model to make a combined 3D model. As such, the combined 3D model includes all the participants and the objects within the virtual environment.

Thereafter, a view (i.e. an image) of the combined model is created for each participant to view on their associated computer monitor. A participant's view is rendered using computer graphics from the point of view of the participant's virtual pose within the virtual environment.

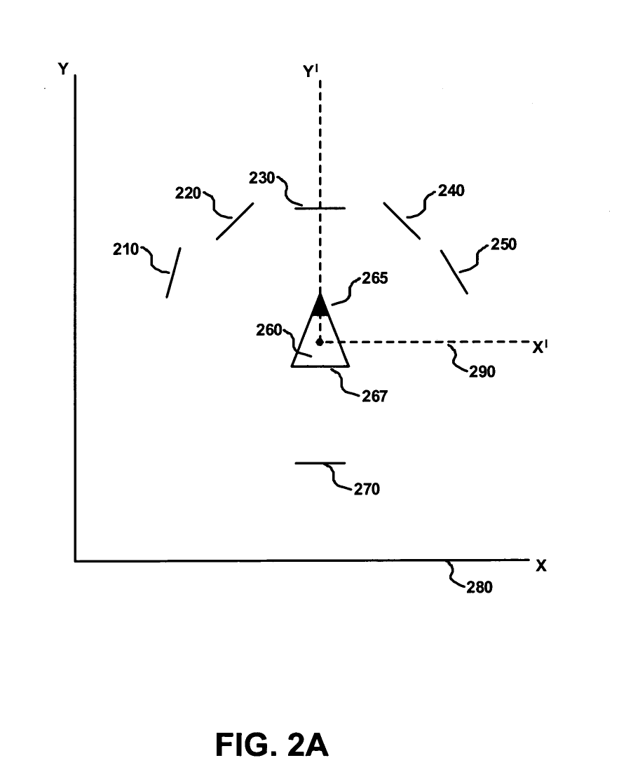

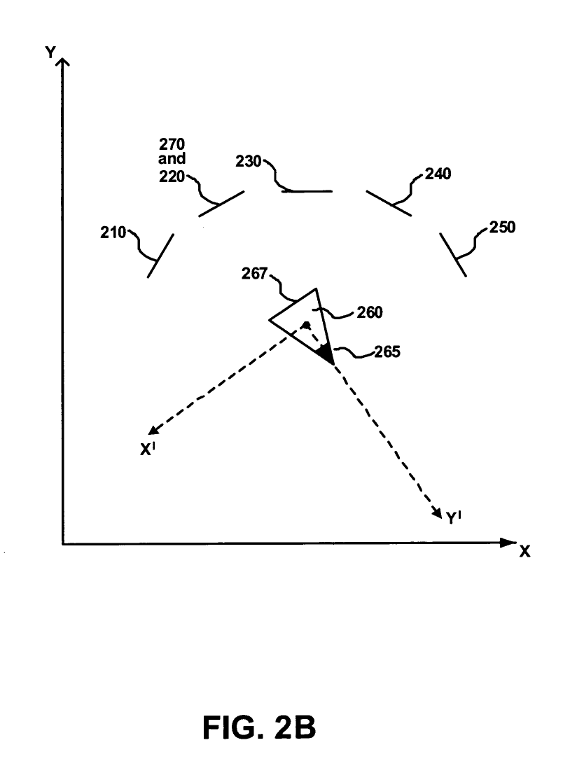

FIG. 2A and FIG. 2B are diagrams illustrating the relationship between a reference coordinate system and an object based coordinate system that is tied to an object, wherein the object is located within both coordinate systems, in accordance with embodiments of the present invention. In both FIG. 2A and FIG. 2B, the reference coordinate system 280 is represented by the X-Y coordinate system. Also, in FIG. 2A and FIG. 2B, the object based coordinate system 290 is represented by the X′-Y′ coordinate system. As will be described, the object based coordinate system 290 can move in relation to the reference coordinate system 280.

Although in the present embodiment, the reference coordinate system 280 and the object based coordinate system 290 are shown in two dimensions, other embodiments of the present invention are well suited to providing extensive coverage of the object for reference coordinate 280 and object based coordinate 290 systems of three dimensions.

In FIG. 2A, the reference coordinate system 280 represents a coordinate system of a physical space. The reference coordinate system 280 is illustrated within the X-Y coordinate space of FIG. 2A. For instance, the reference coordinate system 280 defines the space that surrounds the object 260 and a camera array (e.g., camera array 100) that acquires video streams of the object 260. The object 260 is free to rotate and move about the reference coordinate system 280. For instance, the object is free to position and orient itself in two or three dimensions if the reference coordinate system is described in two or three dimensions, respectively. Also, in another embodiment, the orientation is further described within the six degrees of freedom (e.g., pan, tilt, roll, etc.), especially if the reference coordinate system is described in three dimensions.

Also shown in FIG. 2A is the object based coordinate system 290. The object based coordinate system 290 is illustrated within the X′-Y′ coordinate space of FIG. 2A. In FIG. 2A, the Y axis of the reference coordinate system 280 is parallel to the Y′ axis of the object based coordinate system 290.

The object based coordinate system 290 remains fixed to the object 260. That is, the orientation and position of the object 260 remains fixed within the object based coordinate system 290. For instance, the object based coordinate system 290 may be centered at the center of the object. As illustrated in FIG. 2A, the front of the object represented by point 265 lies along the positive side of the Y′ axis, and the right side of the object falls along the positive side of the X′ axis. In one instance if the object represents a human torso, the object based coordinate system is centered around the center of the human torso (e.g., the center of the top of the head), and the Y′ axis describes the line down which the human torso is pointed towards.

As shown in FIG. 2A, various viewpoints of the object 260 are provided. The viewpoints include viewpoint 210, viewpoint 220, viewpoint 230 viewpoint 240 and viewpoint 250. Each of the viewpoints 210, 220, 230, 240 and 250 are taken from a reference camera acquisition module, such as those in the camera array 100. In the present embodiment, the reference camera acquisition modules associated with viewpoints 210, 220, 230, 240 and 250 are fixed within the reference coordinate system 280. However, the viewpoints 210, 220, 230, 240 and 250 move within the object based coordinate system 290, depending on the position and orientation of the object 260 within the reference coordinate system 280. That is, as the position and orientation of the object changes within the reference coordinate system 280, the viewpoints 210, 220, 230, 240, and 250 of the reference cameras will rotate around the object, as if they are moving, within the object based coordinate system 290.

In FIG. 2A, video streams of the viewpoints 210, 220, 230, 240, 250 are taken at one time (e.g., t=0). As shown in FIG. 2A, at t=0, actual images acquired from the viewpoints 210, 220, 230, 240, and 250 do not include images of the back 267 of the object 260. That is, captured images of the object 260 show the left, right, and front sides of the object. As such, at t=0, there may not be sufficient images acquired from viewpoints 210, 220, 230, 240 and 250 to reconstruct and render a view of the object taken from the rear of the object 260.

Virtual viewpoint 270 illustrates a viewpoint that is fixed within the object based coordinate system 290, as shown in FIG. 2A. The virtual viewpoint 270 is permanently fixed to the back of the object 260. For instance, if the object 260 were a human head or torso, the virtual viewpoint 270 would provide a view of the back of the head. More particularly, the virtual viewpoint 270 would provide a view of the back of the object 260 (e.g., back of the head) irrespective of the position or orientation of the object 260 within the reference coordinate system 280.

As a result, many virtual viewpoints of the object can be defined that illustrate fixed viewpoints of the object within the object based coordinate system. As a group, these virtual viewpoints (e.g., a subset of virtual viewpoints) may provide extensive coverage of the object 260. For instance, another virtual viewpoint may describe a right-rear view of the object 260; or another virtual viewpoint may describe a left-rear view of the object 260; or another viewpoint may describe a view of the rear of the object 260 taken from above; or another viewpoint may describe a view of the rear of the object 260 taken from below; etc.

Each of the virtual viewpoints can be associated with a virtual camera. That is, the virtual camera is not an actual camera, but is representative of a viewpoint of the object 260 as if taken from the viewpoint of the virtual camera within the object based coordinate system. For purposes of the following discussion, a virtual camera that is fixed within the object based coordinate system is oriented to capture an associated virtual viewpoint of the object 260. Using the previous examples, one virtual camera may capture a right rear view of the object 260, or a left-rear view of the object 260, or the rear of the object, etc.

A tracking system (not shown) tracks the position and orientation of the point 265 of the object 260 within the reference coordinate system 280. By way of illustration only, the object 260 can represent the head of human participant. The point 265 represents the front of the head. More particularly, the tracking system tracks the position and orientation of the object based coordinate system 290 within the reference coordinate system 280. As such, the tracking system provides information to translate a point in the reference coordinate system 280 to a corresponding point in the object based coordinate system 290, and vice versa. As such, viewpoints taken from a position in the reference coordinate system 280 can be translated to a viewpoint taken from a position in the object based coordinate system, and vice versa. In general, the tracking system provides translation between the reference coordinate system 280 and the object based coordinate system 290.

The present embodiment is well suited to using any type of tracking system, such as a head tracking system, or point tracking system that is well suited to providing translation information between the reference coordinate system 280 and the object based coordinate system 290.

FIG. 2B is a diagram illustrating the relationship between the reference coordinate system 280 and the object based coordinate system 290 at time (t=t₁), in accordance with one embodiment of the present invention. As such, the video streams of the viewpoints 210, 220, 230, 240 and 250 are taken at time t=t₁. The actual images acquired from viewpoints 210, 220, 230, 240, and 250 are taken at a different time from those images taken in FIG. 2A. For instance, the object and the object based coordinate system 290 has rotated by approximately 160 degrees in relation to the reference based coordinate system 280 from its position as illustrated in FIG. 2A.

Because of the position and orientation of the object 260 in FIG. 2B, the virtual viewpoint 270 coincides with the viewpoint 220. As a result, there are sufficient images acquired from viewpoints 210, 220, 230, 240 and 250 to reconstruct and render a view of the back 267 of the object 260 at t=t₁. More specifically, the tracking system provides for translation between the reference coordinate system 280 and the object based coordinate system 290. As such, at any point in time, the tracking system provides sufficient information to track when the virtual viewpoint 270 falls within the field-of-view of any of the viewpoints 210, 220, 230, 240, and 250. That is, the present embodiment is able to track when the virtual viewpoint 270 coincides with any of the viewpoints 210, 220, 230, 240, and 250.

For instance, the images acquired from the viewpoint 220 may be associated with a virtual viewpoint 270 of the back 267 of the object 260. These images taken at time t=t, may be stored and associated with the virtual viewpoint 270 for later view construction, especially, when the object 260 is in a position and orientation where the back 267 is not within the field-of-view of any of the viewpoints 210, 220, 230, 240, and 250, as illustrated in FIG. 2A. That is, the images stored and associated with the virtual viewpoint 270 may be used to reconstruct and render a view of the object taken from arbitrary perspectives representing viewpoints within the coordinate space of an immersive virtual environment within which the object 260 can be found.

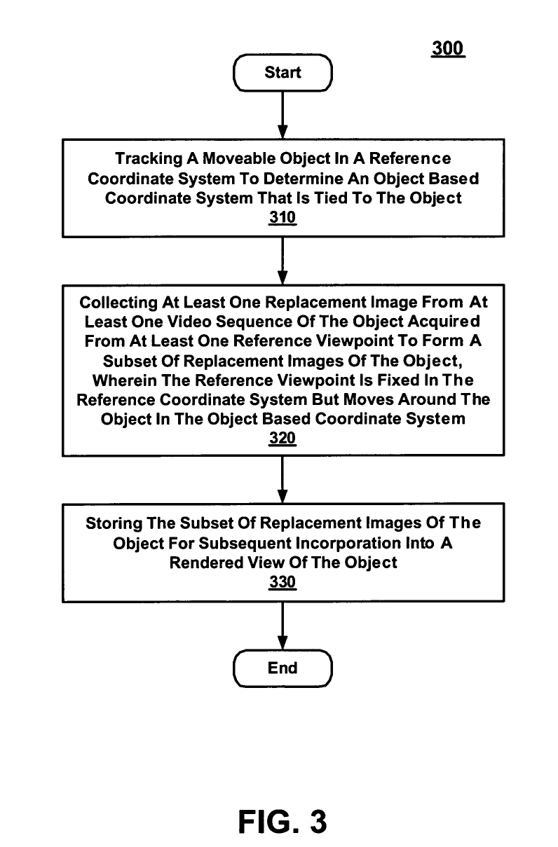

The flow chart 300 in FIG. 3 illustrates steps in a computer implemented method for providing extensive coverage of an object using virtual cameras, in accordance with one embodiment of the present invention. The flow chart 300 can be implemented within a system that is acquiring video-sequences of an object from one or more reference image capturing devices (e.g., cameras) simultaneously, such as the camera array 100. The system is capable of reconstructing one or more images of a video-sequence of the object as seen from an arbitrary perspective representing a viewpoint within a coordinate space of an immersive virtual environment within which the object can be found. That is, renderings of the object are generated using the video sequences of the object that is taken from a virtual viewpoint within the coordinate space of the immersive virtual environment. As such, the embodiment of the present invention is capable of providing video texture information needed to render the object from a new virtual viewpoint that is not supported by current views of the reference cameras. Various reconstruction techniques, as well as new-view synthesis techniques, can be used to render views of the object from the new virtual viewpoint.

At 310, the present embodiment tracks the moveable object in a reference coordinate system. By tracking the moveable object, the present embodiment is able to determine an object based coordinate system that is tied to the object. That is, as described previously, by tracking the position and orientation of the moveable object within the reference coordinate system, proper translation is provided between the reference coordinate system and the object based coordinate system. As such, the present embodiment is capable of translating a position and/or orientation within the reference coordinate system to a position and/or orientation within the object based coordinate system, and vice versa. Movement of the object includes movement from one point to another as well as rotation within the six degrees of freedom previously described (e.g., pan, tilt, roll, etc.),

In another embodiment, reference camera viewpoints fixed within the reference coordinate system and the tracking system are initialized. In that way proper translation between the reference coordinate system and the object based coordinate system is established, such that proper translation is provided for the reference camera viewpoint from the reference coordinate system to the object based coordinate system.

Furthermore, by tracking the position and orientation of the moveable object, proper translation between a coordinate system of the immersive virtual environment and the object based coordinate system and the reference coordinate system is provided. As such, views of the object within the immersive virtual environment can be translated to a view of the object within the object based coordinate system, as well as to a view of the object within the reference coordinate system.

In one embodiment, a three dimensional (3D) model of the object exists in order to establish the object based coordinate system. That is, the 3D model is tied, or fixed, to the object based coordinate system. The 3D model is orientable within the reference based coordinate system, and because of the tracking system, proper translation is provided between the reference coordinate system and the object based coordinate system.

Further, in one embodiment, the object is rigid, or quasi rigid. That is, the object slowly changes relative to the temporal frame-rate of the video acquisitions from the reference cameras. In addition, the 3D model is extended to bodies made of articulated quasi-rigid links. In this case, a number of dynamically coupled coordinate systems exist, wherein each dynamically coupled coordinate system is associated to a separate link.

At 320, the present embodiment collects at least one replacement image from at least one video sequence of the object to form a subset of replacement images of the object. The at least one video sequence provides at least one current image of the object. The at least one replacement image is acquired from at least one reference viewpoint that is fixed within the reference coordinate system, but moves around the object in the object based coordinate system. That is, the reference viewpoint is associated with a virtual reference image capturing device (e.g., a virtual camera) that is virtually capturing the at least one replacement image. In other embodiments, the virtual reference image capturing device is capturing a sequence of images that is associated with the reference viewpoint. In this way, images that were generated previously and stored are associated with particular fixed viewpoints of the object within the object based coordinate system. For instance, a view of the back of the object (e.g., a human torso) that is not within a current view of the object may be substituted with proper replacement images to generate a rendered view of the rear of the torso.

In one embodiment, each of the replacement images in the subset of images are associated with a virtual viewpoint of the object taken from a viewpoint or view direction in the object based coordinate system that are different. In this way, extensive coverage of the object can be provided even if currently acquired images do not provide sufficient video texture information.

Correspondingly, the subset of replacement images can be constructed to provide extensive coverage of the object. For instance, the subset of replacement images can provide extensive coverage of the back of a torso. In this case, the subset of replacement images is associated with varying viewpoints of the object from the object based coordinate system to provide the extensive coverage. As such, gaps in the coverage can be ascertained when the subset of replacement images is incomplete. These gaps correspond to corresponding images that are associated from a viewpoint in the object based coordinate system. The present embodiment is capable of collecting those corresponding images when they are acquired, and understanding from which viewpoints in the object based coordinate system they were taken for proper association within the subset of replacement images.

In one embodiment, the at least one replacement image is collected opportunistically whenever it is acquired by an associated reference camera. For instance, this could be at a time when the object presented a rear-view to one or more of the reference cameras. In another embodiment, instruction is provided for movement of the object in the reference coordinate system to obtain a corresponding replacement image for the subset of replacement images. In addition, the present embodiment can explicitly request the object to be positioned and oriented within the reference coordinate system to provide an extensive, and possibly complete set of images for the subset of images. In another embodiment, after gaps are determined in the subset of replacement images, instruction is provided for movement of the object in the reference coordinate system to obtain corresponding replacement images from virtual viewpoints associated with those gaps.

In still another embodiment, the collection of replacement images occurs on an image by image basis. That is, for an image acquired in a video sequence from a reference camera, a virtual viewpoint is determined for that image in the object based coordinate system. In another embodiment, the collection of replacement images occurs on a video sequence by video sequence basis. This is possible since the tracking system provides for translation between the reference coordinate system and the object based coordinate system. Thereafter, the present embodiment determines if the subset of replacement images is missing a view of the object from the virtual viewpoint. If the subset of replacement images is missing a view of the object from the virtual viewpoint, then the image taken from the reference camera is inserted into the subset of replacement images corresponding to that virtual viewpoint. For instance, if an image of the back of a torso of an object is acquired, and is missing from the subset of replacement images, then that image of the back of the torso becomes and is inserted into the subset of replacement images for that particular virtual viewpoint. Thereafter, for requested views of the object from the virtual viewpoint in the object based coordinate system, if the currently acquired images of the object cannot render a view of the object from the virtual viewpoint, then corresponding replacement images are used to render a view of the object from the virtual viewpoint.

At 330, the present embodiment stores the subset of replacement images of the object. In this way, selected replacement images are used for subsequent incorporation into a rendered view of the object that is taken from viewpoint of the object in which current images of the object are unable to render or support. For instance, at a particular instance in time, five reference cameras surround the front and sides of an object (e.g., a torso), but no cameras provide a view of the back of the object. As such, there are no current video textures available to fill a view of the back of the object that is rendered from a virtual viewpoint within a coordinate space of an immersive virtual environment of which the object is found.

In the present embodiment, selected replacement images of the object that correspond to images of the back of the head from the requested virtual viewpoint can be used to generate a rendered view of the object from the virtual viewpoint within the coordinate space of the immersive virtual environment. That is, the present embodiment, incorporates replacement images from the subset of replacement images for generating renderings of the object for hidden views of the object that are not covered by currently acquired images.

In still another embodiment, the replacement images in the subset of replacement images are dynamically updated to provide the most current images of the object. This can be accomplished by timestamping the images in the subset of replacement images. In this case, new and more recent images of the object acquired from a virtual viewpoint can be inserted into the subset of replacement images for corresponding images at the same virtual viewpoint.

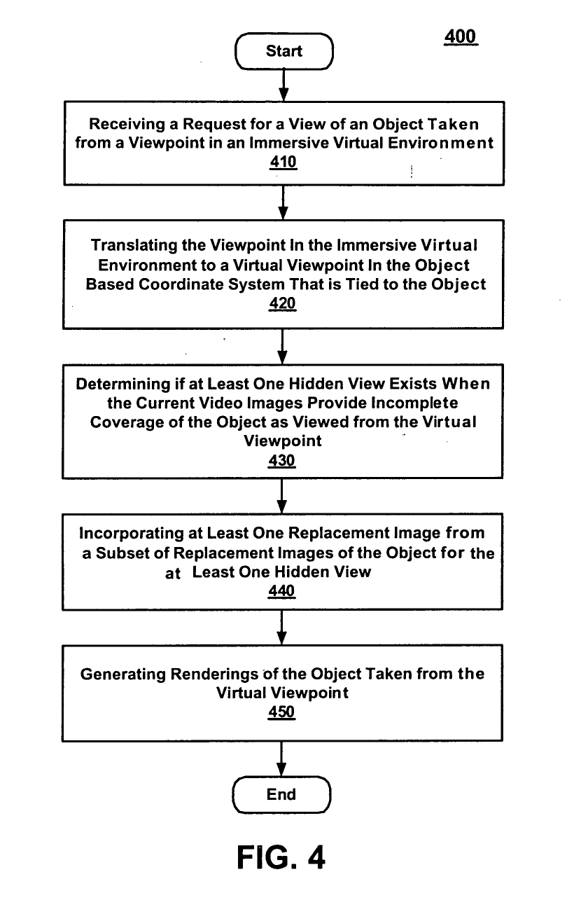

FIG. 4 is a flow chart 400 illustrating a computer implemented method for providing extensive coverage of an object using virtual cameras, in accordance with one embodiment of the present invention. The flow chart 400 can be implemented within a system that is acquiring video-sequences of an object from one or more reference cameras simultaneously, such as the camera array 100. The system is capable of reconstructing one or more images of a video-sequence of the object as seen from an arbitrary perspective representing a viewpoint within a coordinate space of an immersive virtual environment within which the object can be found. That is, renderings of the object are generated using the video sequences of the object that is taken from a virtual viewpoint within the coordinate space of the immersive virtual environment. As such, the embodiment of the present invention is capable of accessing video texture information needed to render the object from a new virtual viewpoint that is not supported by current views of the reference cameras. Various reconstruction techniques, as well as new-view synthesis techniques, can be used to render views of the object from the new virtual viewpoint.

At 410, the present embodiment receives a request for a view of an object taken from the perspective of a viewpoint in an immersive virtual environment. For instance, a view taken within the immersive virtual environment is requested that views the back of the object.

At 420, the present embodiment is capable of translating the viewpoint in a coordinate space of the immersive virtual environment to a virtual viewpoint in an object based coordinate system that is tied to the object. In addition, as discussed previously, because of a tracking system, positions and orientations within the object based coordinate system can be translated to positions and orientation within a reference coordinate system.

At 430, the present embodiment determines if at least one hidden view exists from the currently acquired images of the object. That is, the present embodiment determines if there is incomplete coverage of the object such that video texture information needed to render the object from the requested virtual viewpoint is not fully available in the currently acquired images from the reference cameras. These hidden views are associated with corresponding virtual viewpoints defining the gaps in coverage.

At 440, the present embodiment incorporates at least one replacement image from the subset of replacement images of the object. The at least one replacement image defines a corresponding virtual viewpoint of the object that corresponds to a hidden view associated with a gap in the currently acquired images of the object.

At 450, the present embodiment uses video texture information from at least one image from the subset of replacement images for that particular viewpoint. As such, the object is rendered from the virtual viewpoint that is not supported by the currently acquired images from the reference cameras. In this way, these previously stored images can be used to render the object in a natural manner. As stated previously, various reconstruction techniques, as well as new-view synthesis techniques, can be used to render views of the object from the new virtual viewpoint.

In another embodiment, further refinement of the visual hull of the object is possible from the additional virtual camera viewpoint of the object. That is, the silhouette contour from this virtual viewpoint (e.g., virtual viewpoint 270) can be used in a 3D visual-hull geometry reconstruction algorithm. This silhouette contour is taken as if from an additional virtual reference camera (e.g., from the rear of the object 260 in FIG. 2). The visual-hull improvement from this virtual reference camera will depend upon the consistency of its silhouette with respect to the silhouettes from other virtual and reference cameras having later data.

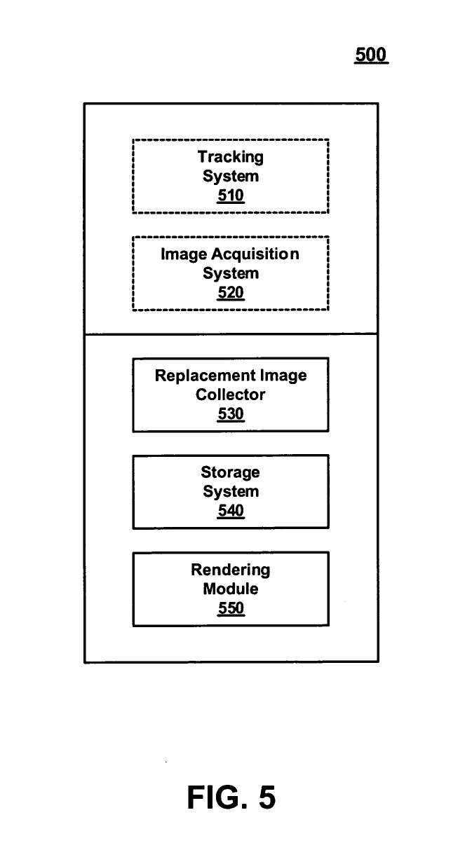

FIG. 5 is a block diagram of a system 500 for generating video texture information to provide extensive coverage of an object using virtual cameras. The system comprises a replacement image collector 530, a storage system 540, and a rendering module 550. Optionally the system 500 can include or incorporate a tracking system 510, and an image acquisition system 520. In this manner, embodiments of the present invention are well suited for integration with legacy devices that may already include a tracking system 510 and an image acquisition system 520. That is, embodiments of the present invention are well suited to integrate elements of legacy device (e.g., tracking system 510 and an image acquisition system 520) to generate video texture information to provide extensive coverage of an object using virtual cameras.

The replacement image collector 530 collects at least one replacement image of an object taken from a viewpoint of a virtual camera fixed in an object based coordinate system that is tied to the object. The at least one replacement image is collected from current images that are acquired from at least one real-time video sequence of the object, wherein the video sequence includes at least one image of the object. As such, the replacement image collector 530 collects replacement images, including the at least one replacement image, to form a subset of replacement images associated with the object.

The system 500 also comprises at least one optional reference image capturing device (e.g., camera) for acquiring the current images from at least one real-time video sequence of the object. The real-time video sequences are acquired from at least one corresponding reference viewpoint that is fixed in a reference coordinate system. The object is located in the reference coordinate system. However, the reference viewpoint moves around the object in the object based coordinate system whenever the object moves or rotates in the reference coordinate system.

In addition, the optional tracking system 510 tracks the object in a reference coordinate system to provide for translation between the reference coordinate system and the object based coordinate system. The tracking system 510 provides for translation between the reference coordinate system to the object based coordinate system that is tied to the moveable object. As such, position and orientation within the reference coordinate system can be translated to a position and orientation within the object based coordinate system, and vice versa.

The replacement images from the current images form the subset of replacement images of the object. That is, as images are acquired from the one or more optional reference image capturing devices, the replacement image collector is able to determine if those current images correspond to views in the subset of replacement images from virtual viewpoints in the object based coordinate system, and whether there are gaps in the subset of replacement images. If the current images correspond to gaps in the subset of replacement images, then those current images are collected for later view construction of the object and geometry refinement.

The system 500 also includes a storage system 540. The storage system 540 stores the subset of replacement images for subsequent incorporation into a rendered view of the object.

A rendering module 550 is also included in system 500 to render views of the object. The views of the object are taken from arbitrary perspectives representing viewpoints within the coordinate space of an immersive virtual environment, which is translated to viewpoints within the object based coordinate system. In one embodiment, the rendering module 550 uses at least one replacement image in the subset of replacement images. As such, in the present embodiment, the rendering module is capable of incorporating replacement images to generate renderings of the object for hidden views of the object that are not covered by currently acquired images.

In another embodiment, the system 500 also comprises an initialization module for initializing each reference camera viewpoint in the reference coordinate system to a virtual viewpoint in the object based coordinate system. The system 500 also includes a gap filling module in still another embodiment that determines gaps in the subset of replacement images for a plurality of virtual viewpoints. The gap filling module is capable of providing instruction for movement of the object in the reference coordinate system to obtain corresponding replacement images that fill in the gaps. The system 500 also includes an up-dating module in another embodiment for dynamically up-dating the subset of replacement images with newer and more recent images of the object that are acquired from currently acquired images.

While the methods of embodiments illustrated in flow charts 300 and 400 show specific sequences and quantity of steps, the present invention is suitable to alternative embodiments. For example, not all the steps provided for in the methods are required for the present invention. Furthermore, additional steps can be added to the steps presented in the present embodiment. Likewise, the sequences of steps can be modified depending upon the application.

The preferred embodiment of the present invention, a method and system for providing extensive coverage of an object using moving virtual cameras, is thus described. While the present invention has been described in particular embodiments, it should be appreciated that the present invention should not be construed as limited by such embodiments, but rather construed according to the below claims.

What is claimed is:

1. A method for providing extensive coverage of an object using virtual cameras, comprising:
tracking a moveable object in a reference coordinate system to determine an object based coordinate system that is tied to said object;
collecting at least one replacement image from at least one video sequence of said object acquired from at least one reference viewpoint to form a subset of replacement images of said object, wherein said reference viewpoint is fixed in said reference coordinate system but moves around said object in said object based coordinate system; and
storing said subset of replacement images of said object for subsequent incorporation into a rendered view of said object.

2. The method of claim 1, further comprising:
acquiring current images from said at least one video sequence of said object; and
generating renderings of said object taken from a virtual viewpoint of said object in said object based coordinate system.

3. The method of claim 2, further comprising:
incorporating said at least one replacement image from said subset of replacement images for generating said renderings of said object for hidden views of said object that are not covered by said current images.

4. The method of claim 2, further comprising:
implementing a new-view synthesis technique to generate said renderings of said object.

5. The method of claim 1, further comprising:
associating said at least one replacement image with a virtual viewpoint of said object taken from a view direction in said object based coordinate system

6. The method of claim 5, wherein said collecting replacement images further comprises:
determining gaps in said subset of replacement images for a plurality of virtual viewpoints that provide extensive coverage of said object; and
providing instruction for movement of said object in said reference coordinate system to obtain corresponding replacement images from virtual viewpoints associated with said gaps.

7. The method of claim 1, wherein said collecting replacement images further comprises:
acquiring an image from said at least one video sequence of said object;
determining a virtual viewpoint said image is taken in said object based coordinate system;
determining if said subset of replacement images is missing a view of said object from said virtual viewpoint; and
inserting said image as said at least one replacement image into said subset of replacement images when said view of said object is missing.

8. The method of claim 1, further comprising:
initializing said at least one reference viewpoint within said object based coordinate system.

9. The method of claim 1, further comprising:
timestamping images in said subset of replacement images; and
dynamically updating said subset of replacement images with newer and more recent images of said object acquired from said at least one video sequence.

10. The method of claim 1, further comprising:
further refining a visual hull of said object from an additional virtual camera viewpoint in said object based coordinate system.

11. A system for generating video texture information to provide extensive coverage of an object using virtual cameras, comprising:
an image collector for collecting at least one replacement image of an object taken from a viewpoint of a virtual camera fixed in an object based coordinate system tied to said object, wherein said at least one replacement image is collected from current images acquired from at least one real-time video sequence of an object to form a subset of replacement images of said object;
a storage system for storing said subset of replacement images for subsequent incorporation into a rendered view of said object; and
a rendering module for rendering a view of said object using said at least one replacement image that is taken from an arbitrary perspective in said object based coordinate system.

12. The system of claim 11, wherein said at least one real-time video sequence is taken from a viewpoint that is fixed in a reference coordinate system but moves around in said object based coordinate system.

13. The system of claim 11, further comprising:
a tracking system for tracking said object in a reference coordinate system to determine said object based coordinate system.

14. The system of claim 11, further comprising:
at least on reference image capturing device for acquiring said current images.

15. The system of claim 11, wherein said object is a moveable object.

16. The system of claim 11, wherein said rendering module comprises:
at least one new view synthesis module for generating real-time renderings of said object from said at least one video sequence, wherein said real-time renderings at any point in time are taken from a virtual viewpoint of said object in said object based coordinate system.

17. The system of claim 16, wherein said at least one new view synthesis module incorporates said at least one replacement image to generate said real-time renderings of said object for hidden views of said object that are not covered by said current images.

18. The system of claim 11, further comprising:
an initialization module for initializing said at least one reference camera viewpoint within said object based coordinate system.

19. The system of claim 11, further comprising:
a gap filling module for determining gaps in said subset of replacement images for a plurality of virtual viewpoints that provide extensive coverage of said object, and providing instruction for movement of said object in said reference coordinate system to obtain corresponding replacement images that fill in said gaps.

20. The system of claim 11, further comprising:
an up-dating module for dynamically up-dating said subset of replacement images with newer and more recent images of said object that are acquired from said at least one video sequence.

21. A computer readable medium for storing program instructions that, when executed, implement a method for providing extensive coverage of an object using virtual cameras, comprising:
accessing tracking information of a moveable object in a reference coordinate system to determine an object based coordinate system that is tied to said object;
collecting at least one replacement image from at least one video sequence of said object acquired from at least one reference viewpoint to form a subset of replacement images of said object, wherein said reference viewpoint is fixed in said reference coordinate system but moves around said object in said object based coordinate system; and
storing said subset of replacement images of said object for subsequent incorporation into a rendered view of said object.

22. The computer system of claim 21, wherein said method further comprises:
acquiring current images from said at least one video sequence of said object; and
rendering said object from a virtual viewpoint of said object in said object based coordinate system.

23. The computer system of claim 22, wherein said method further comprises:
incorporating said at least one replacement image from said subset of replacement images for generating said rendering of said object for hidden views of said object that are not covered by said current images.

24. The computer system of claim 22, wherein said method further comprises:
implementing a new-view synthesis technique to generate said renderings of said object.

25. The computer system of claim 21, wherein said method further comprises:
associating said at least one replacement image with a virtual viewpoint of said object taken from a view direction in said object based coordinate system

26. The computer system of claim 25, wherein said collecting replacement images in said method further comprises:
determining gaps in said subset of replacement images for a plurality of virtual viewpoints that provide extensive coverage of said object; and
providing instruction for movement of said object in said reference coordinate system to obtain corresponding replacement images from virtual viewpoints associated with said gaps.

27. The computer system of claim 21, wherein said collecting replacement images in said method further comprises:
acquiring an image from said at least one video sequence of said object;
determining a virtual viewpoint said image is taken in said object based coordinate system;
determining if said subset of replacement images is missing a view of said object from said virtual viewpoint; and
inserting said image as said at least one replacement image into said subset of replacement images when said view of said object is missing.

28. The computer system of claim 21, wherein said method further comprises:
initializing said at least one reference viewpoint within said object based coordinate system.

29. The computer system of claim 21, wherein said method further comprises:
timestamping images in said subset of replacement images; and
dynamically updating said subset of replacement images with newer and more recent images of said object acquired from said at least one video sequence.

30. The computer system of claim 21, wherein said method further comprises:
further refining a visual hull of said object from an additional virtual camera viewpoint in said object based coordinate system.
